(19) United States
(12) Patent Application Publication
(10) Pub. No.: US 2012/0242809 A1
(43) Pub. Date: Sep. 27, 2012

(54) VIDEO SURVEILLANCE APPARATUS USING DUAL CAMERA AND METHOD THEREOF

(76) Inventors: Ben WHITE, Surrey (GB); Neil Robinson, Surrey (GB); Yeon Hak Choo, Seoul (KR)

(21) Appl. No.: 13/423,850

(22) Filed: Mar. 19, 2012

(30) Foreign Application Priority Data
Mar. 22, 2011 (KR) 10-2011-0025124

(51) Int. Cl. H04N 7/18; H04N 13/04

(52) U.S. Cl. 348/51; 348/159; 348/E13.075; 348/E07.085

(57) ABSTRACT

The present invention relates to a video surveillance apparatus and method using a dual camera, which is capable of applying any camera videos with a result of video analysis made based on one selected from videos provided from a special purpose camera, such as a thermal image camera, and a visible light camera. Since the video surveillance apparatus and method is capable of arranging a visible light camera and a special-purpose camera in the same surveillance area, securing FOV differences between these cameras as pixel matching parameters between images by the medium of the same space corresponding to an image of each camera, performing selective video analysis for one of these parameters, and checking a result of the analysis in any camera images through the matching information in the same way, it is possible to guarantee autonomy of video switching, continuity of object tracking in video switching, and high reliability.

### CROSS-REFERENCE TO RELATED APPLICATION

This application claims the benefit of Korean Application No. 10-2011-0025124, filed on Mar. 22, 2011, with the Korean Intellectual Property Office, the disclosure of which is incorporated herein by reference.

### BACKGROUND OF THE INVENTION

1. Field of the Invention

The present invention relates to a video surveillance apparatus and method using a dual camera, and more particularly, a video surveillance apparatus and method using a dual camera, which is capable of applying any camera videos with a result of video analysis made based on one selected from videos provided from a special purpose camera, such as a thermal image camera, and a visible light camera.

2. Description of the Related Art

With advance of various imaging equipments, intelligent video surveillance technologies have been developed for surveiling events based on object motion within a video obtained by relevant imaging equipment according to a predetermined criterion while detecting or tracking objects through analysis on the video. In particular, as such object detection and tracking and event surveillance approach provides more precise and diverse detections due to a variety of algorithms, intelligent video surveillance markets are expanding day by day.

A visible light camera has been generally used for current surveillance systems which detect movement of objects or track the objects through analysis on a video obtained by the visible light camera and provide an alarm if there occurs a specified event.

However, when the general visible light camera is used, in some cases, due to insufficient amount of light, reflection or movement of light, inflow of direct light ray, or other noises, a false alarm may occur or objects may not be detected, or object tracking is broken off to lower reliability for tracking. In particular, in case of a wide surveillance area, it is often difficult to secure a proper level of illuminance for the entire surveillance area and quality of video analysis sources may be deteriorated due to motion of unspecified light or noises such as yellow sands, dusts and so on.

In particular, in recent years, an edge type surveillance system in which intelligent IP cameras having a video analysis capability are used to transmit a surveillance video if only there occurs a particular event, thereby dispersing a load of a central control center and significantly reducing the total amount of traffics is being preferred than a centralized surveillance system in which a central control center simply collects videos of cameras and analyzes the collected videos in a lump. Accordingly, since effective video surveillance should be achieved with only limited computational resources of a video analysis device implemented in each camera, it is difficult to add a complicated configuration for mitigation of the above-mentioned visible camera limitation or perform an excessive computation.

Accordingly, there is a need for an approach to increase reliability of video surveillance dramatically while reducing a computational load of cameras as low as possible.

In the meantime, in recent years, with significant reduction in costs for resolution of visible light cameras, a surveillance system employing a high resolution camera having a resolution of more than megapixel is being used. However, for video analysis, since a computational load for the video analysis increases geometrically depending on a resolution, an edge type camera incorporating a video analysis unit uses a system for analyzing and transmitting only a portion of the entire video area (due to a limit in bandwidth) by converting a current resolution video into a lower resolution video to be analyzed, rather than analyzing a megapixel resolution video itself, and, based on a result of the analysis, if necessary, determining a main surveillance area as a video analysis and transmission area. Since a desired portion of the megapixel video can be selectively surveiled, this system can select a video area of a transmittable size within the megapixel video without physical movement of the camera, which provide an effect similar to PTZ and is therefore also referred to as “E-PTZ or digital PTZ.”

In order to achieve effective surveillance for the megapixel video, analysis for the entire video has to be performed simultaneously with analysis for a partial video to be actually surveiled and transmitted, which results in increase in a load of the video analysis unit incorporated in the camera and hence increase in camera costs.

Even in this case, there is still a problem of low reliability due to insufficient amount of light, reflection or movement of light, inflow of direct light ray, or other visible noises, which are limits as to the visible light camera, as mentioned previously.

In order to partially overcome this problem, a combined surveillance system has appeared which uses a plurality of cameras or a combination of a visible light camera and a special-purpose camera (for example a thermal image camera or an infrared camera) capable of overcoming the problem of the visible light camera.

Such a combined surveillance system may employ a stereo camera unit including a plurality of visible light cameras, a dual visible light camera unit having different surveillance areas, a hybrid dual camera unit including an infrared camera and a visible light camera, etc.

The stereo camera unit is used to provide a cubic effect to a surveillance video or achieve effective calibration and the dual visible light camera unit having the different surveillance areas is used in combination of a wide area surveillance camera and an enlarged surveillance camera for effective surveillance. However, both of these units still have limits due to ambient environments and noise since they use only the visible light cameras.

In case of combination of the infrared camera and the visible light camera, a limit of the visible light camera can be mitigated when the infrared camera is used. However, in a hybrid dual camera unit being currently used, one of the visible light camera and the infrared camera is selectively used according to situations, such as using the visible light camera by day and using the infrared camera by night. That is, these cameras are switched according to situations. However, since video analysis in such switching has to be again carried out in compliance with a video of each camera, continuity of surveillance disappears. Since an operator who finally checks abnormality in a central control center is a human, a video of the visible light camera to comply with the human vision is suitable for the operator to comprehend ambient environments easily. However, in case where an event occurs, only a video of the infrared camera is used to check abnormality, which may lead to a risk of misjudgement. In addition, when the video of the infrared camera is switched to the video of the visible light camera, there arises a problem of missing of existing video analysis results.

Accordingly, there is a need for a novel video surveillance apparatus and method using a dual camera unit which is capable of overcoming a limit of a visible light camera, verifying a video of a desired camera to allow an operator to understand an abnormal situation easily, and maintaining real time continuity of video analysis results.

### SUMMARY OF THE INVENTION

Accordingly, it is an object of the present invention to provide a video surveillance apparatus and method using a dual camera unit including a visible light camera and a special-purpose camera such as a thermal image or an infrared camera, which is capable of performing video analysis through a video of one camera having a higher surveillance effect and displaying a result of the analysis on a video of another camera, so that continuity of surveillance and result display can be maintained even if an operator selects any camera video as an output video.

It is another object of the present invention to provide a video surveillance apparatus and method using a dual camera unit, which is capable of real time video analysis for the entire surveillance area while performing E-PTZ for a desired surveillance area, application of a result of the analysis to an E-PTZ screen displaying a partial area, and reflection of the real time video analysis result even in the event of changes in a video, such as E-PTZ scene switching, position movement, zooming and so on.

To achieve the above objects, according to an aspect of the invention, there is provided a video surveillance apparatus using a dual camera, including: a dual camera unit including a visible light camera and a special-purpose camera which are adjacent to each other, the special-purpose camera having a property different from a property of the visible light camera; a calibration unit which includes surveillance space calibration information for each camera of the dual camera unit; a video analysis unit which analyzes a video of one selected from videos of the cameras of the dual cameras by referring to the calibration information; a video matching unit which mutually matches videos of the two cameras of the dual camera unit by the medium of the surveillance space by using the calibration information for each camera of the calibration unit; and a representation unit which selects a video of one to be analyzed by the video analysis unit, of the cameras of the dual camera unit according to an external control signal or a preset criterion, selects a video of a camera to be provided to the outside, and displays a result of the analysis of the video analysis unit on a corresponding position of the outside provision video matched through the video matching unit.

Preferably, the calibration unit calculates the calibration information through adjustment of arrangement and size of three-dimensional grids and standard solid objects displayed on the 3D grids based on a relationship between a surveillance space and a camera image for each of the cameras of the dual camera unit.

Preferably, the video matching unit uses a rotation matrix and an inter-position translation for matching between the videos of the cameras of the dual camera unit having the same space information through the calibration unit.

Preferably, the calibration unit uses measurement information in installation of the dual camera unit to calculate a scaling matrix between the videos of the cameras and an inter-position translation.

Preferably, the video matching unit uses the scaling matrix and the inter-position translation of the calibration unit to calculate pixel positions of one camera image corresponding to pixel positions of the other camera image according to a result of the analysis of the video analysis unit.

Preferably, the visible light camera of the dual camera unit has a higher resolution than the special-purpose camera, a display selection area is adjusted according to an external control signal through the representation unit, and the video analysis unit determines a display selection area of the visible light camera such that all target objects are displayed depending on contents of the video analysis.

Preferably, the representation unit displays information of video analysis of a camera, which is analyzed by the video analysis unit, of the cameras of the dual camera unit according to an external control signal, on a video of a camera which is not analyzed by the video analysis unit, or displays the video analysis information on the video of the camera analyzed by the video analysis unit.

Preferably, the representation unit selects one of the videos of the dual camera unit, overlaps videos of a plurality of cameras, or combines videos of these cameras.

According to another aspect of the invention, there is provided a video surveillance apparatus using a dual camera, which performs object tracking through a dual camera unit including a visible light camera and a special-purpose camera which are adjacent to each other, the special-purpose camera having a property different from a property of the visible light camera, both cameras being calibrated for a surveillance space, including: a video analysis unit which performs object tracking for a video of the special-purpose camera; a video matching unit which mutually matches videos of the two cameras by the medium of the surveillance space by using calibration information for each of the cameras; and a representation unit which displays a result of the video analysis by the video analysis unit on the video of the special-purpose camera according to an external control signal, or displays the result of the video analysis on a matching position in the video of the visible light camera through the video matching unit.

According to still another aspect of the invention, there is provided a video surveillance method using a dual camera including a visible light camera and a special-purpose camera which are adjacent to each other, the special-purpose camera having a property different from a property of the visible light camera, including the steps of; performing calibration for a surveillance space for each camera of the dual camera unit; acquiring matching information by mutually matching videos of the two cameras of the dual camera unit by the medium of the surveillance space by referring to a result of the calibration; performing video analysis for one of the cameras and calculating a result of the video analysis; and displaying the calculated result on a video subjected to the video analysis according to an external control signal, or displaying the calculated result on a video of a camera not subjected to the video analysis according to matching information between the videos of the cameras.

According to an embodiment of the present invention, since the video surveillance apparatus and method using the dual camera unit is capable of acquiring matching information using at least one of a parameter obtained through calibration between cameras, a two-dimensional image obtained through each camera, and a three-dimensional space oriented by each camera, analyzing a video of one selected from the cameras, performing object tracking based on a result of the analysis, and matching and displaying a position of a bounding box corresponding to a result of the object tracking to a video of the other camera, even when video analysis is performed for a video of one camera having a higher surveillance effect, a result of the analysis can be displayed on a video of another camera, which may result in efficient video surveillance depending on a selection by an operator.

According to an embodiment of the present invention, since the video surveillance apparatus and method using the dual camera unit including a visible light camera and a special-purpose camera such as a thermal image or an infrared camera is capable of performing video analysis through a video of the thermal image or the infrared camera and reflecting a result of the analysis in a megapixel video through matching, it is possible to achieve real time video analysis for the entire surveillance area while performing E-PTZ for a desired surveillance area, application of a result of the analysis to an E-PTZ screen displaying a partial area, and reflection of the real time video analysis result even in the event of changes in a video, such as E-PTZ scene switching, position movement, zooming and so on.

According to an embodiment of the present invention, since the video surveillance apparatus and method using the dual camera unit including a visible light camera and a special-purpose camera such as a thermal image or an infrared camera is capable of arranging a visible light camera and a special-purpose camera in the same surveillance area, securing FOV differences between these cameras as pixel matching parameters between images by the medium of the same space corresponding to an image of each camera, performing selective video analysis for one of these parameters, and checking a result of the analysis in any camera images through the matching information in the same way, it is possible to guarantee autonomy of video switching, continuity of object tracking in video switching, and high reliability.

### BRIEF DESCRIPTION OF THE DRAWINGS

The above and/or other aspects and advantages of the present invention will become apparent and more readily appreciated from the following description of the embodiments, taken in conjunction with the accompanying drawings of which:

FIG. 1 is a conceptual view for explaining the concept an embodiment of the present invention.

FIG. 2 is a view showing configuration of a video surveillance apparatus using a dual camera according to an embodiment of the present invention.

FIG. 3 is a conceptual view for explaining an example of a calibration method according to an embodiment of the present invention.

FIG. 4 is a conceptual view for explaining a video matching method according to an embodiment of the present invention.

FIG. 5 is a conceptual view for explaining a video matching method according to an embodiment of the present invention.

FIG. 6 is a view for explaining an example of a video surveillance method using a dual camera according to an embodiment of the present invention.

FIG. 7 is a view showing configuration of a video surveillance apparatus according to another embodiment of the present invention.

FIGS. 8 and 9 are views for explaining an example of a video surveillance method using a dual camera according to another embodiment of the present invention.

FIG. 10 is a view for explaining an example of a video surveillance method using a dual camera according to still another embodiment of the present invention.

### DETAILED DESCRIPTION OF THE PREFERRED EMBODIMENT

Hereinafter, embodiments of the present invention will be described in detail with reference to the accompanying drawings.

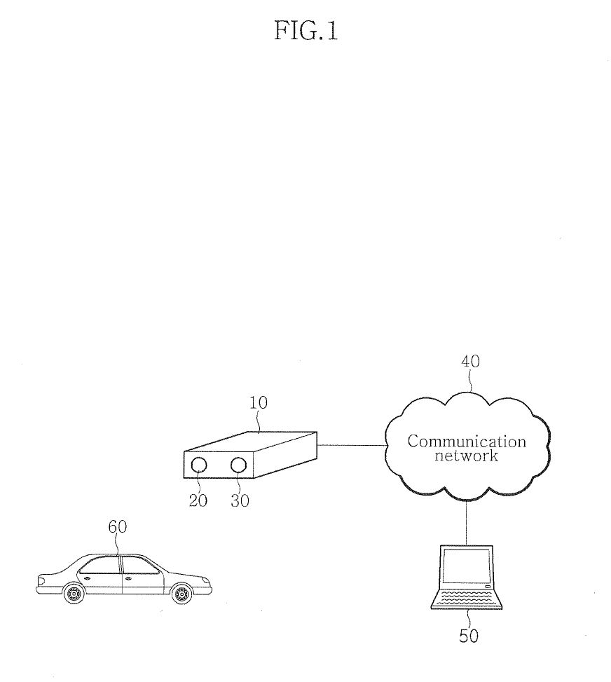

FIG. 1 shows an exemplary surveillance system to which a video surveillance apparatus using a dual camera according to an embodiment of the present invention is applied. Referring to FIG. 1, the surveillance system includes a video surveillance apparatus 10 including a dual camera unit composed of different kinds of cameras 20 and 30 which are placed adjacent to each other and configured to surveil (or monitor) an object 60 (for example, a car) in the same surveillance area; and a control center 50 which is connected to the video surveillance apparatus 10 via a communication network 40, provides control information on the dual camera unit, and checks a video provided by the video surveillance apparatus 10.

The different kinds of cameras 20 and 30 of the dual camera unit are preferably a visible light camera and a special-purpose camera, such as a thermal image camera, an infrared camera, a vision camera, a filter camera or the like, which has characteristics different from those of the visible light camera.

Although the special-purpose camera will be illustrated with the thermal image camera or the infrared camera in the following embodiments, it should be understood that the special-purpose camera encompasses all kinds of cameras having characteristics different from and higher surveillance capability than the visible light camera.

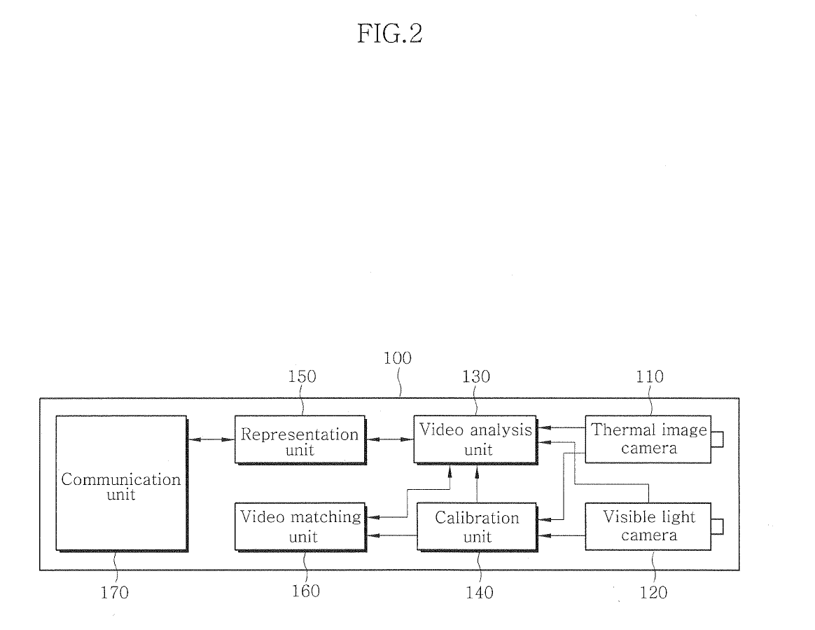

FIG. 2 is a view showing configuration of a video surveillance apparatus using a dual camera according to an embodiment of the present invention. Referring to FIG. 2, the video surveillance apparatus includes a dual camera unit composed basically of a visible light camera 120 and a thermal image camera 110 as a special-purpose camera which are placed adjacent to each other; a calibration unit 140 which associates two-dimensional images of the cameras with surveillance spaces based on information such as parameters obtained from a result of calibration for the dual camera unit; a video matching unit 160 which includes information (or algorithm) on video matching between the cameras 110 and 120, which is obtained based on calibration information of the calibration unit 140; a video analysis unit 130 which analyzes one selected from videos of the cameras 110 and 120 by referring to the calibration information of the calibration unit in order to acquire video surveillance results such as object detection, object tracking, object type identification, speed detection, event generation check and so on; a representation unit 150 which selects one of the cameras, which is to be connected to the video analysis unit 130, according to an external control signal or a preset criterion, selects a video to be provided to the outside, and displays a video surveillance result of the video analysis unit 130 for the provided video at a corresponding position matched through the video matching unit 160; and a communication unit 170 which transmits video information of the representation unit 150 through a communication network, receives a control signal, and provides the received control signal to the representation unit 150.

In this embodiment, the representation unit 150 may display video analysis information of a camera example the thermal image camera 110) analyzed by the video analysis unit 130 among videos of the cameras 110 and 120 on a video of another camera (for example the visible light camera 130) which is not analyzed by the video analysis unit 130 or display the video analysis information on the video of the camera analyzed by the video analysis unit, according to an external control signal (that is, a control signal provided from the control center 50), and the videos selected or output by the camera unit 110 and 120 to be analyzed may be arbitrarily operated by the control center 50. Of course, the videos may be automatically operated according to preset conditions (for example, it may be configured that a video of the thermal image camera is analyzed if external illuminance is lower than a predetermined level, and a video of the visible light camera is analyzed if the external illuminance is higher than the predetermined level. In addition, the videos may be provided randomly or sequentially).

In addition, the representation unit 150 may select one of the videos of the dual camera unit, overlap the videos of these cameras, or combine the videos of these cameras, and such selected, overlapped or combined videos may be operated in various ways. In this embodiment, although such videos are operated in various ways, the video analysis can be performed consistently through the camera unit optimal to the current situations and results of the analysis can be output to any cameras as desired, so that the videos can be analyzed continuously in real time and the results of the analysis can be output as desired to any form of output videos, which is different from the existing systems which cannot perform continuous video analysis according to selection of output objects.

Although not shown, the video surveillance apparatus may further include a storage unit which stores at least one of the videos of the dual camera unit and the videos of the representation unit.

For example, when object tracking is performed through the thermal image camera 110 in the evening, a result of the tracking may be displayed on the video of the thermal image camera 110 or the video of the visible light camera 120 according to selection of the representation unit 150, and switching therebetween can be freely performed to provide a continuous tracking process.

It is imperative for a process of video matching between the cameras to display the analysis result of the video analysis unit on a video of another camera, which may be achieved through a procedure of obtaining calibration information used to information on a relationship between a two-dimensional video of a camera and a surveillance space and video matching information used to match relationships between two-dimensional videos of the cameras through a relationship between a two-dimensional video of each camera obtained through the calibration information and the surveillance space.

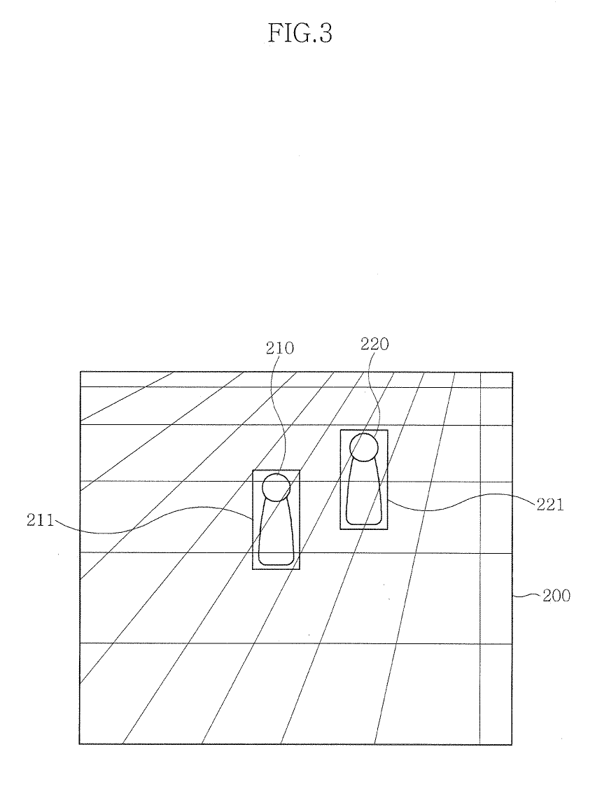

FIG. 3 is a conceptual view for explaining an example of a camera calibration method according to an embodiment of the present invention. As shown in the figure, a relationship between a surveillance space and an image (or video) for a camera is used to calculate calibration information through adjustment of arrangement and size of three-dimensional grids and standard solid objects displayed on the 3D grids.

Since the camera video corresponds to an actual projection on a 3D space 200, a grid 210 corresponding to the ground is displayed on the video in an overlaying manner and a plurality of 3D objects 210 and 220 having the standard size is displayed at different positions on the ground. Therefore, the grid 210 is adjusted to a position corresponding to the ground of an actual video, and the positions of the 3D objects 210 and 220 are adjusted to adjust size of the 3D objects 210 and 220 to a size of a similar object (person in this embodiment, a person in an actual video not shown) appearing on the video. A grid spacing of the grid 210 is adjusted when the size of the 3D objects 210 and 220 is adjusted.

A 3D space modeling corresponding to a 2D video space can be performed through the adjustment of the grid 210 and the 3D objects 210 and 220.

The 3D objects are illustrated with a standard human body corresponding to a main surveillance object of the video. However, in addition to such a human body model, different kinds of vehicles, articles, labeling objects and so on can be displayed on the space in compliance with their standard size.

As a result, the calibration unit can match the ground of the actual video to the grid through the adjustment of the 3D objects and the 3D space based on an actual image obtained by each of the cameras, and can achieve modeling for a space similar to an actual space through the adjustment of the 3D object to match objects existing on different positions of the actual image, which means that size, position, speed and so on of objects displayed on the video can be verified to have values similar to actual values. In particular, it is possible to obtain various parameters from which a correlation between a space and a 2D video can be known for mutual correspondence.

Details of the calibration of the calibration unit are disclosed in Korean Patent No. 10-0969576 owned by the applicant.

Thereafter, the calibration information can be provided to the video analysis unit which can then generate information on bounding boxes 211 and 221 for object tracking, which are used to select an object from a background based on the calibration information in a video acquired from each of the cameras, and also perform other various video analyses including kind determination, speed detection and event occurrence detection.

As described above, the calibration may be individually performed for the visible light camera and the thermal image camera to obtain the calibration information for each of the camera.

In particular, since the above-described method can be used to facilitate a space modeling, scaling values between the cameras can be regarded to be equal to each other, thereby facilitating the video matching procedure.

Of course, in addition to the above calibration, it is possible to perform calibration for each camera using a known standard structure simply in order to check information on a relationship between the cameras. For example, pixel positions for edges of the same standard structures between videos of the cameras may be compared to obtain information on rotation matrix or translation between positions.

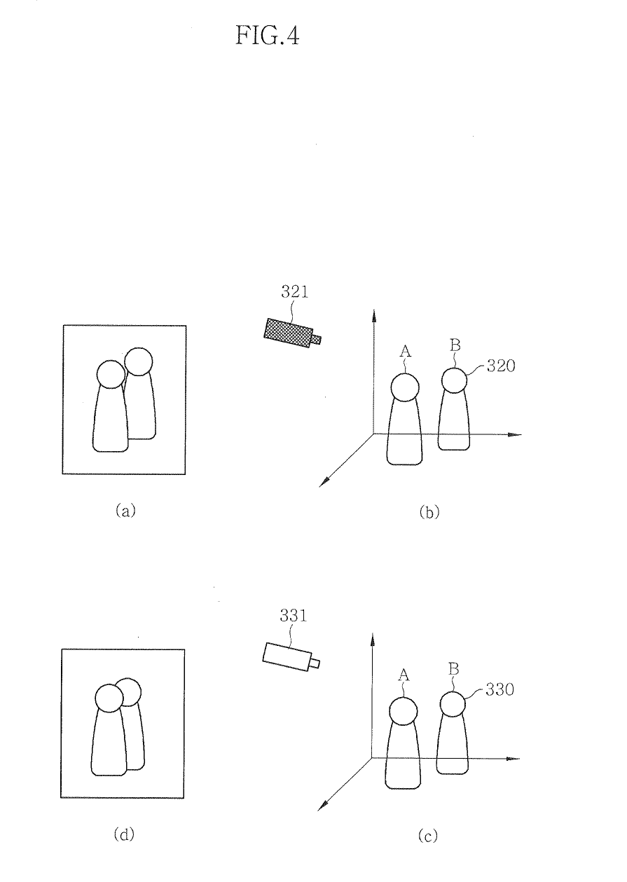

FIG. 4 illustrates an exemplary method of matching videos of the cameras when the calibration information on the relationship between the videos and the space is obtained. For example, when a video 310 as shown in FIG. 4a is a video obtained for a surveillance space 320 by a thermal image camera 321 as shown in FIG. 4b and a video 340 as shown in FIG. 4d is a video obtained for a surveillance space 330 by a visible light camera 331 as shown in FIG. 4c, since the spaces 320 and 330 and physical positions and space modeling values of objects A and B located on the spaces 320 and 330 are substantially similar to each other, it is possible to obtain information on matching between the videos 310 and 340 due to association between spatial relationships of the videos 310 and 340 although the videos 310 and 340 of the thermal image camera 321 and the visible light camera 331 having different field of view (FOV) are more or less dissimilar from each other.

For example, when the thermal image camera performs object tracking to obtain bounding box information for a particular object, this information is converted into information on position and box size on a space corresponding to reference position pixels of each of bonding boxes and pixel information of the visible light camera is calculated using the position information on the space and the calibration information of the visible light camera, thereby allowing positions of the bounding boxes to be represented on the video of the visible light camera.

To express this more mathematically, since a relationship between an image of each camera and a space model can be verified through the above-described calibration process and its scaling values can be regarded to be equal to each other, rotation errors, which occur due to a difference between FOVs of the cameras, and position transformation may be only considered.

This may be expressed by the following equation 1.

x′=Rx+t [Equation 1]

Where, R represents a rotation matrix and t represents inter-position translation.

Then, the same points are set in the cameras and the rotation matrix is obtained from the set points. For example, assuming that pₐ¹ and pₐ² are ground position values for one of the visible light camera and the thermal image camera and p_{b}¹ and p_{b}² are ground position values for the other of the visible light camera and the thermal image camera, a rotation angle θ between grounds of the cameras is expressed by the following equation 2.

$$θ = {cos}^{- 1} ( \frac{( {p}_{a}^{1} - {p}_{a}^{2} ) \cdot ( {p}_{b}^{1} - {p}_{b}^{2} )}{‖ ( {p}_{a}^{1} - {p}_{a}^{2} ) \cdot ( {p}_{b}^{1} - {p}_{b}^{2} ) ‖} ) \qquad [ Equation 2 ]$$

Since the inter-position translation t is p_{b}¹−pₐ¹, combination thereof leads to a final transformation formula as expressed by the following equation 3.

$${x}^{′} = [ \begin{matrix}cos θ & - sin θ \\ sin θ & cos θ\end{matrix} ] x + ( {p}_{b}^{1} - {p}_{a}^{1} ) \qquad [ Equation 3 ]$$

Since the above equation 3 can be used for the video matching unit to obtain information on matching between the cameras, analysis results of the video analysis unit (for example, bounding boxes, tracking trace, speed, kind, event occurrence results and so on) can be applied to objects within the same video.

Matching is possible even if the calibration shown in FIG. 3 is not performed, in which case the video matching unit may obtain a scaling matrix between video images of the cameras and the inter-position translation information when the cameras are installed and set-up, as mentioned earlier. A transformation formula can be obtained through this, and positions of pixels at which the analysis results obtained by the video analysis unit are displayed can be obtained through the transformation formula for matching. For example, the bounding boxes can be displayed by obtaining pixel positions of a video of one camera corresponding to edge pixel positions of a video of the other camera.

Here, since there is a need to consider the scaling and the inter-position translation, a transformation function as expressed by the following equation 4 is used.

x′=Sx+t [Equation 4]

Where, S is a scaling matrix and t is the inter-position translation.

For example, assuming that pₐ¹ and pₐ² are position values for a first camera and p_{b}¹ and p_{b}² are the same position values for a second camera, the scaling matrix S and the inter-position translation t cab be obtained through the following equations 5 and 6, respectively.

$$\begin{matrix}S = [ \begin{matrix}\frac{( {p}_{b}^{1} \cdot x - {p}_{b}^{2} \cdot x )}{( {p}_{a}^{1} \cdot x - {p}_{a}^{2} \cdot x )} & 0 \\ 0 & \frac{( {p}_{b}^{1} \cdot y - {p}_{b}^{2} \cdot y )}{( {p}_{a}^{1} \cdot y - {p}_{a}^{2} \cdot y )}\end{matrix} ] & [ Equation 5 ] \\ t = {p}_{a}^{1} - S {p}_{b}^{1} & [ Equation 6 ]\end{matrix}$$

It should be understood that the above equations 5 and 6 are simplified equations which can be used when two cameras have parallel visual axes and an object to be tracked is relatively remoter than a spacing between the cameras if it is difficult to achieve correct calibration, and these equations may be replaced with other different equations.

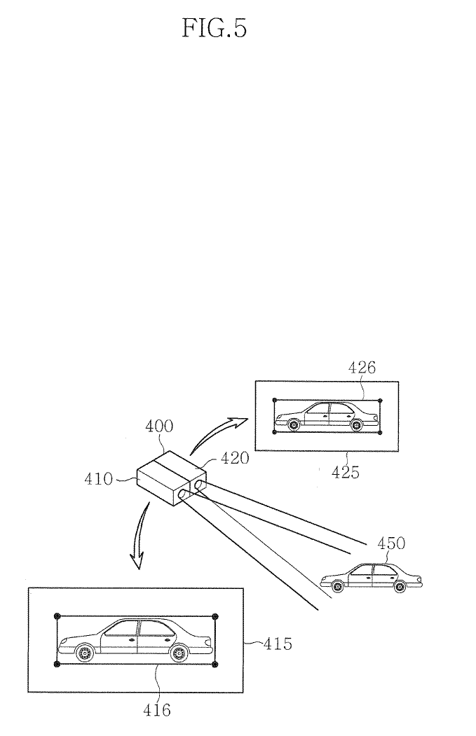

FIG. 5 shows an example of a video matching method when the cameras have videos having different resolutions, in which a video surveillance apparatus 420 includes a visible light camera 410 and a thermal image camera 420.

Referring to FIG. 5, when video analysis based on a video 425 of the thermal image camera 420 is made to detect an object 450 and then obtain information on a bounding box 426, the information on the bounding box 426 is displayed in a bounding box 416 at a corresponding position of a video 415 of the visible light camera 410 associated through the video matching unit. Since a scaling difference appearing between the resolutions is simply an arithmetical difference, this difference can be eliminated if only the video matching unit has information on the resolution of the video 415 of the visible light camera 410.

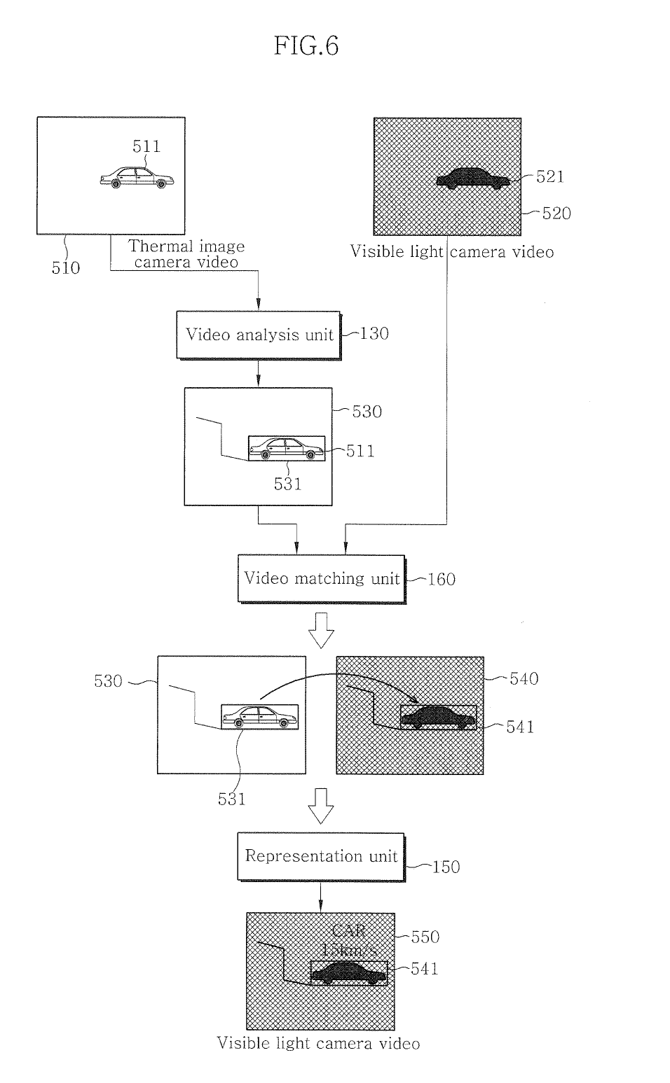

FIG. 6 shows an embodiment of vehicle surveillance performed during the night when it is difficult to achieve security surveillance through the visible light camera under a situation where the thermal image camera and the visible light camera are used to surveil the same surveillance area with the same resolution. This embodiment will be described in conjunction with FIG. 2.

As shown, although a vehicle 511 may be confirmed through a video 510 of the thermal image camera, it is difficult to clearly confirm a vehicle 521 through a video 520 of the visible light camera during the night having low intensity of illumination. In this case, when the video 510 of the thermal image camera is set to be provided to the video analysis unit 130, the image analysis unit 130 can analyze the clear video 510 of the thermal image camera, select an object 511 corresponding to the vehicle and perform object tracking for the object 511 reliably.

A bounding box 531 to select the object 511 is obtained based on a result of the object tracking and, if necessary, analysis information such as kind, movement speed, movement direction and so on of the object can be obtained. In addition, if necessary, it can be confirmed whether or not an event occurs.

If an operator attempts to confirm a surveillance video based on the video of the thermal image camera, the representation unit 150 may transmit the video 530 of the thermal image camera including the video analysis information obtained through the video analysis unit 130, along with necessary information (event occurrence information and so on), via a communication unit.

On the other hand, if the operator attempts to confirm a visible situation through the video 520 of the visible light camera, information of the video analysis unit 130 selected by the operator is transmitted to the video matching unit 160 which then calculates information 541 on a position at which the video analysis information (including position information on the bounding box 531) of the video 530 of the thermal image camera is matched to the video 540 of the visible light camera.

Based on the calculated information 541 on the matching position, the representation unit 150 displays the video analysis result information on the video of the visible light camera obtained in real time, thereby obtaining a video 550 of the visible light camera in which the video analysis result is included. This video 550 is transmitted to the operator via the communication unit.

Thus, the operator can confirm the video analysis result consistently in real time by only selection of a simple output video based on any desired video, and confirm a surveillance area and objects in various ways due to its free switching.

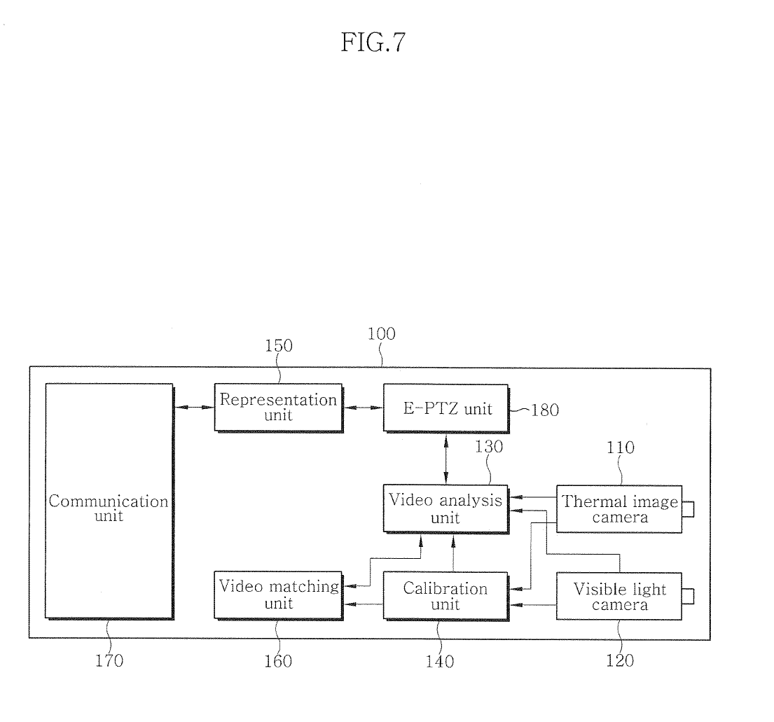

FIG. 7 shows a modification of the video surveillance apparatus 100 shown in FIG. 2. As shown, the video surveillance apparatus 100 further includes an E-PTZ unit 180 which provides an E-PTZ (referred also to as “digital PTZ) function to determine a portion of the video of the visible light camera as a display selection area according to a signal from the representation unit 150 which transmits an external control signal of the video analysis unit 130 or the operator if the visible light camera has a high resolution.

The E-PTZ unit 180 may designate the display selection area of the video of the visible light camera automatically based on an analysis result for the video of the thermal image camera by the video analysis unit 130, or alternatively, may designate the display selection area of the video of the visible light camera under external control by the operator.

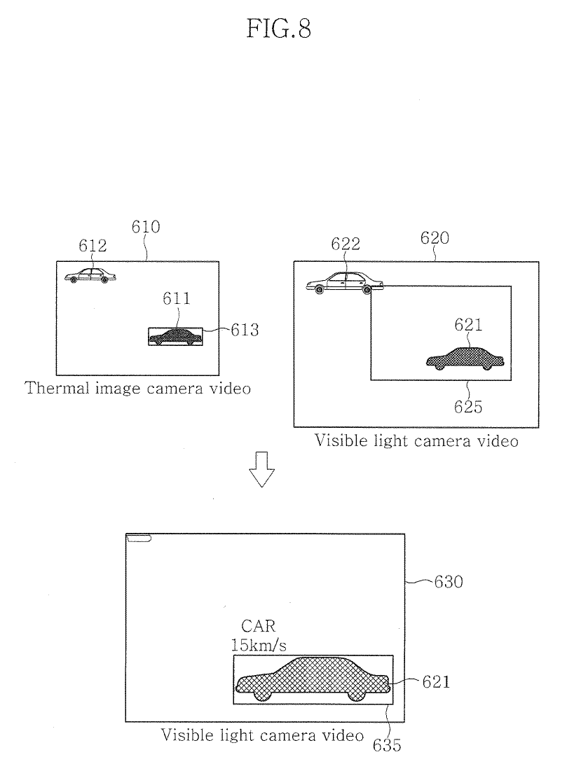

FIG. 8 shows a case where the video of the visible light camera has a resolution different from that of the thermal image camera. In the figure, for example, the video of the visible light camera has a high resolution of a megapixel level and can provide an E-PTZ function.

First, it can be seen from this figure that a video 610 of the thermal image camera subjected to video analysis includes a stationary vehicle 612 and a moving vehicle 611 which is recognized as an object and is displayed with a bounding box 613, i.e., is tracked.

On the other hand, it can be also seen from the figure that a video 620 of the visible light camera has a resolution higher than that of the thermal image camera and picks up the same surveillance area with the higher resolution. A stationary vehicle 622 and a moving vehicle 621 can be also confirmed through the video 620 of the visible light camera.

If an operator does not use an E-PTZ function, the video 620 of the visible light camera is reduce to the same resolution as the video 610 of the thermal image camera and complies with the method of FIG. 6 as described above.

On the contrary, if the operator attempts to confirm a predetermined area 625 having the same resolution as the video of the thermal image camera through the E-PTZ function of the visible light camera, it is possible to obtain correct object tracking information 635 on the vehicle 621 while confirming an enlarged video 630 of the visible light camera using only video matching and information on the E-PTZ selection area without requiring separate complicated hardware configuration and complicated computation.

That is, it is possible to obtain position information of the video of the visible light camera corresponding to position information (for example position of the bounding box) of the video analysis result obtained through the video of the thermal image camera by the video matching unit, and to obtain a correct position to be represented on a screen if it is determined that the position information corresponds to (i.e., belongs to) the display selection area 625.

The representation unit represents the video analysis result with a bounding box 635 at the obtained correct position to be represented on the screen and further represents predetermined analysis information (object type, speed and so on) of the video analysis result obtained by the analysis on the video of the thermal image camera, so that the video analysis result can be displayed in real time on a desired E-PTZ area on the screen using the minimal resources while maintaining the real time video analysis for the overall area. This can be consistently maintained even if the operator attempts to operate the E-PTZ function in real time.

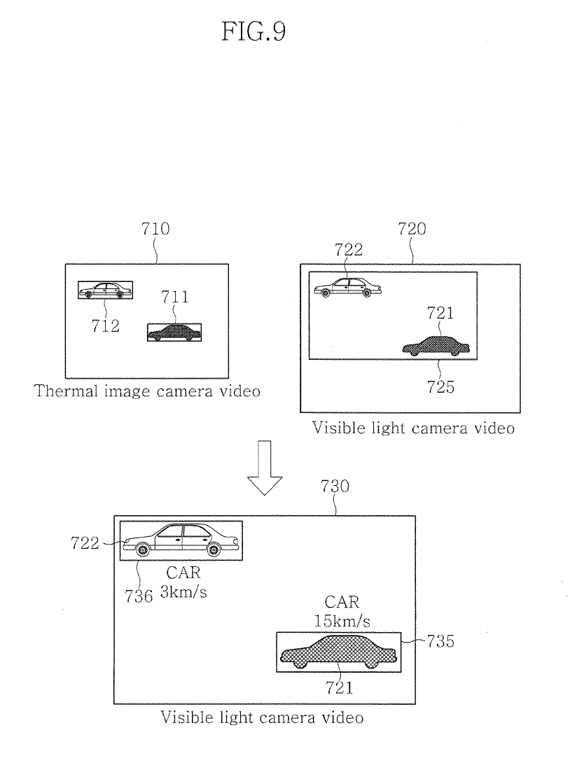

FIG. 9 shows an example of automatic E-PTZ control of the video analysis unit other than the E-PTZ control of the operator. As shown, while a first vehicle 711 continues to move in a video 710 of the thermal image camera, a stationary vehicle 712 begins to move in the opposite direction to the first moving vehicle 711.

In this case, it can be seen that the first vehicle 711 and the second vehicle 712 are both being tracked by object tracking of the video analysis unit performed based on the video 710 of the thermal image camera.

The video analysis unit can automatically designate a display selection area 725 in a video 720 of the visible light camera such that positions of the tacked first and second vehicles 711 and 712 are both included in the display selection area 725, and accordingly, the tacked first and second vehicles 711 and 712 can be both displayed on the display selection area 725 of the video 720 of the visible light camera. In this case, size of the display selection area 725 can be freely selected up to the overall area of the visible light camera in the same area as the thermal image camera. If the size of the display selection area increases over the resolution of the video of the thermal image camera, an actual display video for the display selection area is reduced to scale. In this case, a video analysis result for the video of the thermal image camera may be matched to re-adjust a display position of the vehicles 722 and 721 to the reducing scale.

This allows a video 730 of the visible light camera for a display area of the first and second vehicles 722 and 721 to be provided to an operator. This video 730 includes bounding boxes 735 and 736 and associated information according to the video analysis result.

In the end, the operator can perform reliable surveillance since the video analysis result obtained through the thermal image camera can be displayed in real time through the matching irrespective of how to adjust and utilize the video of the visible light camera.

Even in this case, display of the video of the visible light camera and display of the video of the thermal image camera can be freely switched therebetween depending on a selection by an operator.

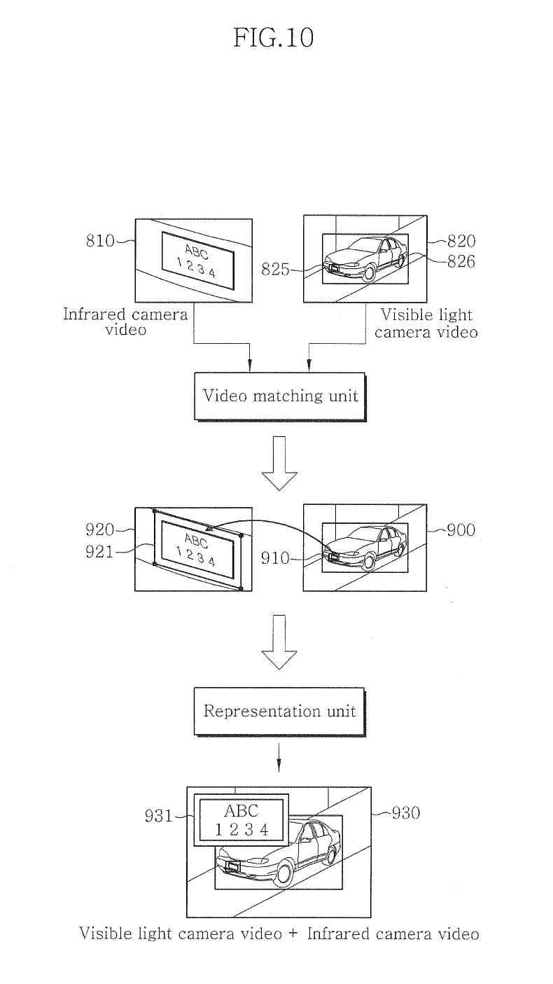

FIG. 10 shows another embodiment of the present invention, where a surveillance area of an infrared camera corresponds to a portion 825 of a surveillance area of a visible light camera. In the shown configuration, substantial video analysis is performed through the video 820 of the visible light camera and the video 810 of the infrared camera provides an enlarged video of a portion corresponding to a predetermined area of the video 820 of the visible light camera.

That is, the video analysis unit performs tracking for the video 820 of the visible light camera for display of a bounding box 826, and the video 810 of the infrared camera provides an enlarged video of a partial area 825 in the video 820 of the visible light camera.

In addition to analysis on size and movement direction of the vehicle, the video analysis unit to analyze the video 820 of the visible light camera detects a front license plate of the vehicle and generates an event if the detected license plate is included in the area 825.

Information on the event generation is provided to an operator and, based on the event generation information from the video analysis unit, the video matching unit calculates position information of a bounding box 921 in a video 920 of the infrared camera corresponding to a position of a bounding box 910 identifying the license plate of the video analysis unit for the video of the visible light camera.

The representation unit may acquire only a video in a matching area according to the position information calculation of the video matching unit, generate a combination video 930 by inserting (931) the acquired video in the video of the visible light camera, and deliver the generated combination video 930 to the operator.

The above-described basic operation mode of the embodiment of the present invention can be applied to a case where cameras in the dual camera unit are disposed adjacent to each other to share at least a portion of a surveillance area as well as a case where resolutions of the cameras are different from each other. In addition, the representation unit can support different types of video combinations, such as selectively outputting one of videos of the dual camera unit, overlapping and outputting videos of a plurality of cameras, combining and outputting the videos of both cameras, etc., thereby maximizing operator's surveillance convenience and increasing reliability of intelligent surveillance.

While the present invention has been particularly shown and described with reference to exemplary embodiments thereof, it will be understood by those skilled in the art that various changes in form and details may be made therein without departing from the spirit and scope of the present invention. The exemplary embodiments are provided for the purpose of illustrating the invention, not in a limitative sense. Thus, it is intended that the present invention covers the modifications and variations of this invention provided they come within the scope of the appended claims and their equivalents.

What is claimed is:

1. A video surveillance apparatus using a dual camera, comprising:
a dual camera unit including a visible light camera and a special-purpose camera which are adjacent to each other, the special-purpose camera having a property different from a property of the visible light camera;
a calibration unit which includes surveillance space calibration information for each camera of the dual camera unit;
a video analysis unit which analyzes a video of one selected from videos of the cameras of the dual cameras by referring to the calibration information;
a video matching unit which mutually matches videos of the two cameras of the dual camera unit by the medium of the surveillance space by using the calibration information for each camera of the calibration unit; and
a representation unit which selects a video of one to be analyzed by the video analysis unit, of the cameras of the dual camera unit according to an external control signal or a preset criterion, selects a video of a camera to be provided to the outside, and displays a result of the analysis of the video analysis unit on a corresponding position of the outside provision video matched through the video matching unit.

2. The video surveillance apparatus according to claim 1, wherein the calibration unit calculates the calibration information through adjustment of arrangement and size of three-dimensional grids and standard solid objects displayed on the 3D grids based on a relationship between a surveillance space and a camera image for each of the cameras of the dual camera unit.

3. The video surveillance apparatus according to claim 2, wherein the video matching unit uses a rotation matrix and an inter-position translation for matching between the videos of the cameras of the dual camera unit having the same space information through the calibration unit.

4. The video surveillance apparatus according to claim 1, wherein the calibration unit uses measurement information in installation of the dual camera unit to calculate a scaling matrix between the videos of the cameras and an inter-position translation.

5. The video surveillance apparatus according to claim 4, wherein the video matching unit uses the scaling matrix and the inter-position translation of the calibration unit to calculate pixel positions of one camera image corresponding to pixel positions of the other camera image according to a result of the analysis of the video analysis unit.

6. The video surveillance apparatus according to claim 1, wherein the visible light camera of the dual camera unit has a higher resolution than the special-purpose camera.

7. The video surveillance apparatus according to claim 6, wherein a display selection area is adjusted according to an external control signal through the representation unit.

8. The video surveillance apparatus according to claim 6, wherein the video analysis unit determines a display selection area of the visible light camera such that all target objects are displayed depending on contents of the video analysis.

9. The video surveillance apparatus according to claim 1, wherein the representation unit displays information of video analysis of a camera, which is analyzed by the video analysis unit, of the cameras of the dual camera unit according to an external control signal, on a video of a camera which is not analyzed by the video analysis unit, or displays the video analysis information on the video of the camera analyzed by the video analysis unit.

10. The video surveillance apparatus according to claim 1, wherein the representation unit selects one of the videos of the dual camera unit, overlaps videos of a plurality of cameras, or combines videos of these cameras.

11. The video surveillance apparatus according to claim 9, further comprising a storage unit which stores at least one of the videos of the cameras of the dual camera unit and the video of the representation unit.

12. A video surveillance apparatus using a dual camera, which performs object tracking through a dual camera unit including a visible light camera and a special-purpose camera which are adjacent to each other, the special-purpose camera having a property different from a property of the visible light camera, both cameras being calibrated for a surveillance space, comprising:
a video analysis unit which performs object tracking for a video of the special-purpose camera;
a video matching unit which mutually matches videos of the two cameras by the medium of the surveillance space by using calibration information for each of the cameras; and
a representation unit which displays a result of the video analysis by the video analysis unit on the video of the special-purpose camera according to an external control signal, or displays the result of the video analysis on a matching position in the video of the visible light camera through the video matching unit.

13. A video surveillance method using a dual camera including a visible light camera and a special-purpose camera which are adjacent to each other, the special-purpose camera having a property different from a property of the visible light camera, comprising the steps of;
performing calibration for a surveillance space for each camera of the dual camera unit;
acquiring matching information by mutually matching videos of the two cameras of the dual camera unit by the medium of the surveillance space by referring to a result of the calibration;
performing video analysis for one of the cameras and calculating a result of the video analysis; and
displaying the calculated result on a video subjected to the video analysis according to an external control signal, or displaying the calculated result on a video of a camera not subjected to the video analysis according to matching information between the videos of the cameras.

14. The video surveillance method according to claim 13, wherein the representation unit selects one of the videos of the video analysis result is displayed in the step of displaying is a video of one of the cameras, an overlap video of the cameras, or a combination of the videos of the cameras.
